(19) United States
(12) Patent Application Publication
(10) Pub. No.: US 2023/0281161 A1
(43) Pub. Date: Sep. 7, 2023

(54) FILE STORAGE SYSTEM

(71) Applicant: Hitachi, Ltd., Tokyo (JP)

(72) Inventors: Takeshi KITAMURA, Tokyo (JP); Ryo FURUHASHI, Tokyo (JP); Mitsuo HAYASAKA, Tokyo (JP); Shimpei NOMURA, Tokyo (JP); Masanori TAKATA, Tokyo (JP)

(73) Assignee: Hitachi, Ltd., Tokyo (JP)

(21) Appl. No.: 17/901,340

(22) Filed: Sep. 1, 2022

(30) Foreign Application Priority Data
Jan. 28, 2022 (JP) 2022-012209

(51) Int. Cl. G06F 16/11; G06F 16/182; G06F 16/188

(52) U.S. Cl. CPC G06F 16/128; G06F 16/119; G06F 16/188; G06F 16/1827

(57) ABSTRACT

Easily provided is a file virtualization function without being affected by an application that accesses a file system.

A CPF node containerizes an application program and an IO Hook program and provides the application program and the IO Hook program to a client, the application program performs call processing on the virtual file system provided by the IO Hook program on the basis of an operation request for a file from the client, the IO Hook program performs processing for updating state management information of the file on the basis of input information or operation content with respect to a virtual file system related to the operation request, and the file virtualization program performs file management processing between a CPF and a CAS on the basis of the state management information and outputs the call processing to a distributed file system program.

### CROSS-REFERENCE TO PRIOR APPLICATION

This application relates to and claims the benefit of priority from Japanese Patent Application No. 2022-012209 filed in January. 28, 2022 the entire disclosure of which is incorporated herein by reference.

### BACKGROUND

The present invention relates to a file storage system.

The amount of digital data, especially file data, is increasing rapidly. Digital data, including data files, needs to be stored for a long period of time for various purposes, for example, in order to meet various legal requirements. In response to such a demand, a system in which a CAS (Content Addressed Storage) device is disposed of in a data center, a NAS (Network Attached Storage) device is disposed of in each base (for example, each business division of a company), the CAS device and the NAS devices are connected by a communication network such as a wide area network (WAN), and centralized data management is performed on the CAS device is conventionally known. Generally, working data is stored on the NAS devices as long as the working data is used, and then the working data is transferred to the CAS device for the purpose of archiving.

A storage system that manages a file data storage provides a file system to a client that operates a file, and also appropriately backs up the file stored in the NAS device to the CAS device. A backup function provided by the storage system includes a function of detecting files generated/updated on the NAS device and asynchronously migrating the files to the CAS device, a stubbing function of deleting files not accessed by the client from the NAS device, and a restoring function of acquiring files from the CAS device when referral thereto again is performed from the client. Hereinafter, in the present specification, the migration function, the stubbing function, and the restoring function provided by the storage system are collectively referred to as a file virtualization function.

As background art in the present technical field, there is Japanese Patent Application Publication No. 2021-157381. This publication discloses a technology in which calling processing for a local file system on the basis of a file operation request from an application in an NAS is performed to cause the local file system to process the file operation request, an IO Hook program performs processing for updating state management information of a file on the basis of input information or operation content with respect to the local file system related to the operation request, and a file virtualization program performs file management processing between the NAS and the CAS based on the state management information.

### SUMMARY

The technology described in Japanese Patent Application Publication No. 2021-157381 requires the creation for linking an IO Hook program as a library to a program for access to a local file system (a network storage program in Japanese Patent Application Publication No. 2021-157381).

Further, in recent years, a virtualization technology that is a technology for virtualizing hardware (for example, a CPU and peripheral devices) by adding a layer of software (for example, an OS) and “hiding” details of a method of interfacing with hardware from a user, and which allows the user to write code for executing several functions without being strongly dependent on an underlying infrastructure, such as a specific OS, a specific vendor, or a specific configuration of hardware, and receive services based on the functions, has been widely used. In a container environment, which is one means of the virtualization technology, a program that accesses a local file system becomes an arbitrary application, and a file virtualization function corresponding thereto is required. When the technology described in Japanese Patent Application Publication No. 2021-157381 is applied in the container environment, it is necessary to perform creation for linking an IO Hook program to any application each time or to perform modification of the application, which requires a large amount of development man-hours and labor.

The present invention has been made in view of the above problems, and an object of the present invention is to provide a file storage system that can easily provide a file virtualization function without being affected by an application that accesses a file system.

In order to solve the above problem, a file storage system according to an aspect of the present invention includes: a plurality of storage nodes that each provide a first file system, and a first storage system in which files are stored by the first file system, wherein a second storage system is available, each storage node includes an application that issues an operation request for the file on the basis of a request from a client, a state information management unit that manages state management information having a state of the file stored therein and further provides a virtual file system based on the first file system to the application, and a file virtualization unit that manages the files stored in the first storage system and the second storage system, the application performs a call processing for the virtual file system based on the operation request for the file, the state information management unit outputs the operation request for the file to the first file system, and performs update processing on the state management information of the file on the basis of input information or operation content with respect to the virtual file system related to the operation request, the distributed file system processes the operation request for the file, and the file virtualization unit performs management processing for the file between the first storage system and the second storage system on the basis of the state management information.

According to the present invention, it is possible to realize a file storage system that can easily provide a file virtualization function without being affected by an application that accesses a file system.

### BRIEF DESCRIPTION OF THE DRAWINGS

FIG. 1 is a diagram illustrating a hardware configuration of a file storage system according to an embodiment;

FIG. 2A is a diagram illustrating an example of a schematic configuration of a CPF of the file storage system according to an embodiment;

FIG. 2B is an illustrative diagram of containerization in the CPF of the file storage system according to the embodiment;

FIG. 2C is a diagram illustrating another example of the schematic configuration of the CPF of the file storage system according to the embodiment;

FIG. 2D is a diagram illustrating an image of a program operation in the CPF of the file storage system according to the embodiment;

FIG. 2E is a diagram illustrating an example of container management data of the file storage system according to the embodiment;

FIG. 3 is a diagram illustrating an example of a schematic configuration of an OBJS of the file storage system according to the embodiment;

FIG. 4 is a diagram illustrating a function of an IO Hook program of the file storage system according to the embodiment;

FIG. 5 is a diagram illustrating a file system that is provided by the file storage system according to the embodiment;

FIG. 6 is a diagram illustrating an example of a management information file of the file storage system according to the embodiment;

FIG. 7 is a diagram illustrating another example of the management information file of the file storage system according to the embodiment;

FIG. 8 is a diagram illustrating an example of a log file of the file storage system according to the embodiment;

FIG. 9 is a diagram illustrating an example of a database of the file storage system according to the embodiment;

FIG. 10 is a flowchart illustrating an example of file/directory creation processing of the file storage system according to the embodiment;

FIG. 11 is a flowchart illustrating an example of file/directory deletion processing of the file storage system according to the embodiment;

FIG. 12 is a flowchart illustrating an example of renaming processing of the file storage system according to the embodiment;

FIG. 13 is a flowchart illustrating an example of file writing processing of the file storage system according to the embodiment;

FIG. 14 is a flowchart illustrating an example of file reading processing of the file storage system according to the embodiment;

FIG. 15 is a flowchart illustrating an example of directory reading processing of the file storage system according to the embodiment;

FIG. 16 is a flowchart illustrating an example of log reflection processing of the file storage system according to the embodiment;

FIG. 17 is a flowchart illustrating an example of file migration processing of the file storage system according to the embodiment;

FIG. 18 is a flowchart illustrating an example of directory migration processing of the file storage system according to the embodiment;

FIG. 19 is a flowchart illustrating an example of file stubbing processing of the file storage system according to the embodiment;

FIG. 20 is a flowchart illustrating an example of OBJS-side file/directory deletion processing of the file storage system according to the embodiment; and

FIG. 21 is a flowchart illustrating an example of crawling processing of the file storage system according to the embodiment.

### DETAILED DESCRIPTION OF THE EMBODIMENT

Hereinafter, embodiments of the present invention will be described with reference to the drawings. The following description and drawings are examples for explaining the present invention and are appropriately omitted and simplified for the sake of clarification of the description. The present invention can also be implemented in various other forms. Unless particularly limited, each component may be singular or plural.

In figures illustrating the embodiments, parts having the same function are denoted by the same reference signs, and repeated descriptions thereof will be omitted.

A position, size, shape, range, or the like of each component illustrated in the drawings may not represent an actual position, size, shape, range, or the like in order to facilitate understanding of the invention. Therefore, the present invention is not necessarily limited to the position, size, shape, range, or the like disclosed in the drawings.

In the following description, various information may be described by expressions such as “table”, “list”, “queue”, and the like, but the various information may be expressed by a data structure other than these. An “XX table”, an “XX list”, and the like may be referred to as “XX information” to show that the information does not depend on the data structure. When identification information is described, expressions such as “identification information”, “identifier”, “name”, “ID”, and “number” are used, but these can be replaced with each other.

Further, in the following description, a configuration of each table is an example, and one table may be divided into two or more tables, or all or some of two or more tables may be one table.

When there are a plurality of components with the same or similar functions, the same reference signs with different subscripts may be used for the description. However, when it is not necessary to distinguish between the plurality of components, the subscripts may be omitted for description.

Further, in the following description, although processing performed by executing a program may be described, a subject of the processing may be a processor (for example, a CPU or a GPU) because determined processing is performed while appropriately using storage resources (for example, a memory) and/or an interface device (for example, a communication port) by the program being executed by the processor. Similarly, a subject of the processing performed by executing a program may be a controller, an apparatus, a system, a computer, or a node having the processor. The subject of the processing performed by executing a program may be a calculation unit or may include a dedicated circuit (for example, an FPGA or an ASIC) that performs specific processing.

Further, in the following description, a “processor (unit)” is one or more processors. At least one processor is typically a microprocessor such as a CPU (Central Processing Unit), but may be another type of processor such as a GPU (Graphics Processing Unit). At least one processor may be single core or multi-core.

Further, at least one processor may be a processor in a broad sense, such as a hardware circuit (for example, FPGA (Field-Programmable Gate Array) or ASIC (Application Specific Integrated Circuit)) that performs some or all of processing.

In the following description, an “interface (unit)” may be one or more interfaces. The one or more interfaces may be one or more communication interface devices of the same type (for example, one or more NICs (Network Interface Cards) ) or may be two or more different types of communication interface devices (for example, NIC and HBA (Host Bus Adapter)).

Further, in the following description, a “memory unit” is one or more memories and may be typically a main storage device. At least one memory in the memory unit may be a volatile memory or a non-volatile memory.

A program may be installed in an apparatus such as a computer from a program source. The program source may be, for example, a program distribution server or a computer-readable storage medium. When the program source is the program distribution server, the program distribution server may include a processor and storage resources that store a distribution target program, and the processor of the program distribution server may distribute the distribution target program to other computers. Further, in the following description, two or more programs may be realized as one program, or one program may be realized as two or more programs.

In the present disclosure, a storage device includes one storage drive such as one HDD (Hard Disk Drive) or SSD (Solid State Drive), a RAID apparatus including a plurality of storage drives, and a plurality of RAID apparatuses. Further, when the drive is an HDD, for example, a SAS (Serial Attached SCSI) HDD may be included, or an NL-SAS (nearline SAS) HDD may be included.

### Embodiment 1

Hereinafter, embodiments will be described with reference to the drawings.

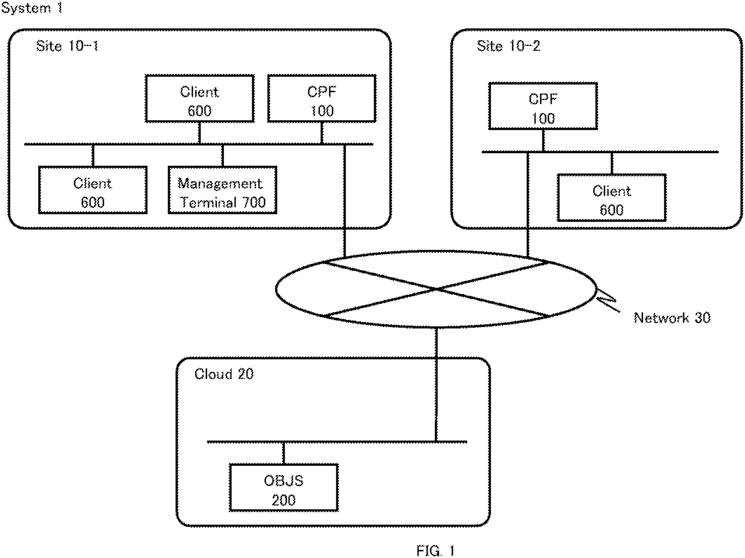

FIG. 1 is a diagram illustrating a hardware configuration of a file storage system according to an embodiment.

A file storage system 1 according to the embodiment includes the sites 10-1 and 10-2, and a cloud 20, and the sites 10-1 and 10-2 and the cloud 20 are connected by a network 30 which is a WAN (Wide Area Network). Although the two sites 10-1 and 10-2 are illustrated in FIG. 1, the number of sites is not particularly limited in the present embodiment.

The site 10-1 includes a CPF (Container Platform) 100, a client 600, a management terminal 700, and the CPF 100, and the client 600 and the management terminal 700 are connected to each other by a LAN (Local Area Network).

A specific configuration of the CPF 100 will be described below. The client 600 is an information processing apparatus such as a computer capable of various information processing, and performs various file operations such as storing a file in the CPF 100 and performing file reading/writing processing. The management terminal 700 performs management of the CPF 100, and performs various operation instructions or the like on the CPF 100, for example, when there is an abnormality in the CPF 100.

The site 10-2 also includes the CPF 100 and the client 600. Hardware configurations of the sites 10-1 and 10-2 illustrated in FIG. 1 are merely examples, and when each site includes at least one CPF 100 and one client 600, the number of sites and other hardware configurations may be adopted.

The cloud 20 includes an OBJS (Object Storage) 200. The OBJS 200 functions as a backup destination of files stored in the CPF 100 of the sites 10-1 and 10-2.

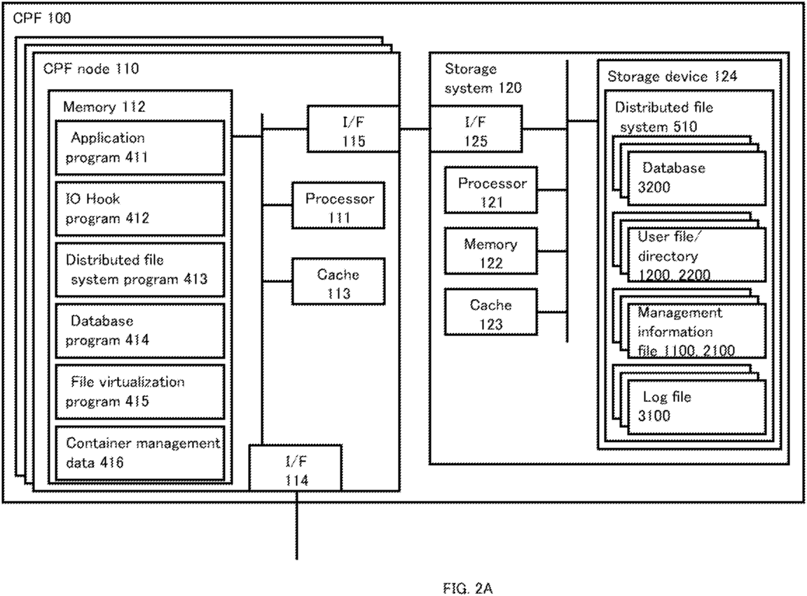

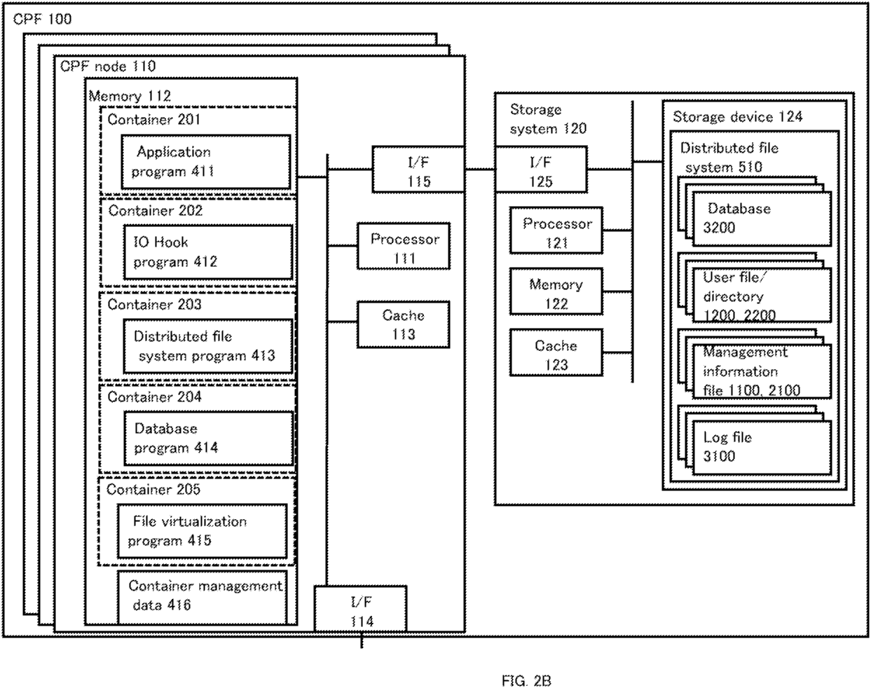

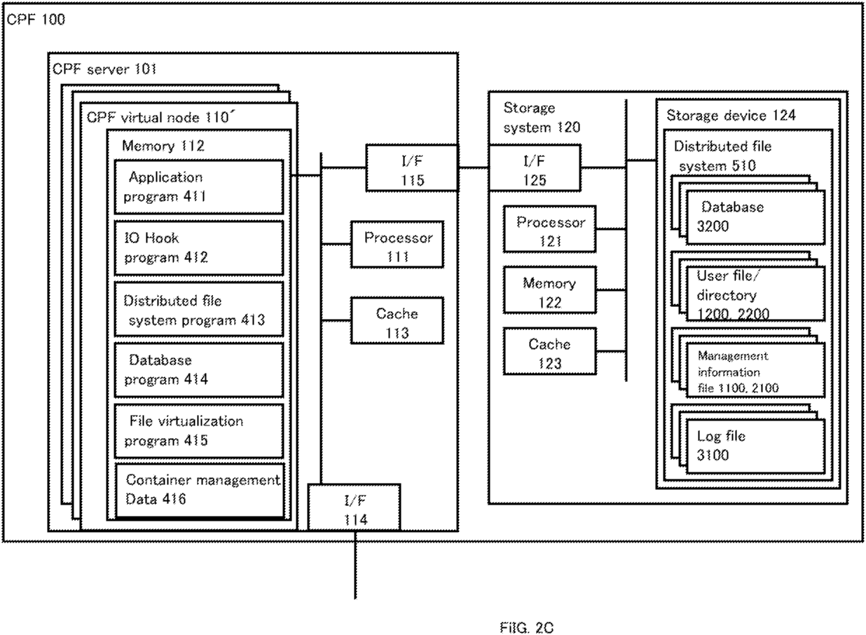

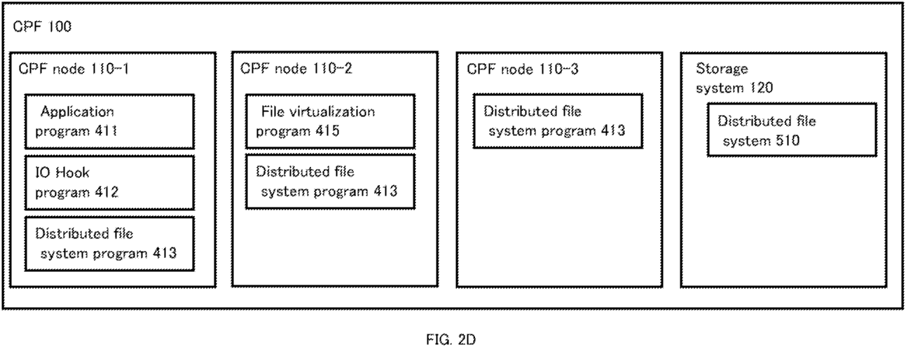

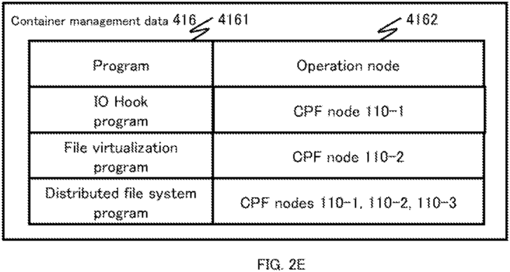

FIG. 2A is a diagram illustrating an example of a schematic configuration of the CPF 100 of the file storage system 1 according to the embodiment.

The CPF 100 includes one or a plurality of CPF nodes (storage nodes) 110 as controllers, and one storage system 120.

Each CPF node 110 includes a processor 111 that performs control of an entire operation of the CPF node 110 and the CPF 100, a memory 112 that stores programs and data used for the operation control of the processor 111, a cache 113 that temporarily stores data written from the client 600 or read from storage system 120, an interface (I/F) 114 that performs communication with the other clients 600 or the like in the sites 10-1 and 10-2, and an interface (I/F) 115 that performs communication with the storage system 120.

The storage system 120 also includes a processor 121 that controls an operation of the storage system 120, a memory 122 that stores programs and data that are used for operation control of the processor 121, a cache 123 that temporarily stores data written from the CPF node 110 or data read from the storage device 124, a storage device 124 in which various files are stored, and an interface (I/F) 125 that performs communication with the CPF node 110.

The memory 112 stores an application program 411, an IO Hook program 412, a distributed file system program 413, a database program 414, a file virtualization program 415, and container management data 416. Although not illustrated, a container infrastructure operates in each CPF node 110 to containerize each program and provide a container to the client 600.

The application program 411 includes all pieces of software for inputting and outputting files such as Excel (registered trademark) or Word (registered trademark) . The application program 411 performs a file operation on the distributed file system 510 in response to a request from the client 600.

The IO Hook program 412 is a program for performing IO Hook processing that is a characteristic of the present embodiment to be described below, and extracts information on IO processing for a file when a system call issued by the application program 411 is called, and performs processing for updating file virtualization management information. Further, the IO Hook program 412 records the log file 3100. The IO Hook program 412 provides a virtual file system to the application program 411. Details of an operation of the IO Hook program 412 will be described below.

The distributed file system program 413 provides a distributed file system to the client 600 and the like. Further, the distributed file system program 413 executes a file operation with respect to the distributed file system 510 on the basis of the system call from the application program 411. The database program 414 manages a database 3200.

The file virtualization program 415 monitors the log file 3100 and performs migration, stubbing, or restoration of the files in the storage device 124.

In the container management data 416, a correspondence relationship between a list of programs stored in each CPF node 110 and the CPF node 110 in which the program is executed is registered, and is shared between the CPF nodes 110. Each CPF node 110 manages the containerization and execution of a program that is executed by the CPF node 110 based on the container management data, and cooperation of the program between the CPF nodes 110.

FIG. 2E is a diagram illustrating an example of the container management data 416 of the file storage system according to the embodiment. The container management data 416 includes a program 4161 and an operation node 4162, a name of the program stored in each CPF node 110 is stored in the program 4161, and a name of the CPF node 110 in which the program is executed is stored in the operation node 4162. In the program 4161 and the operation node 4162, each program such as an identifier or other information that can identify each CPF node may be stored.

An administrator can access any one of the CPF nodes 110 using the management terminal 700, select a program to be operated and the CPF node 110 to be executed from various programs stored in the memory 112, and set and register the program and the CPF node 110 in the container management data 416. Further, the container management data 416 in which the program 4161 and the operation node 4162 have been set and registered is shared with the other CPF nodes 110. The container management data 416 may be shared by the database program 414.

In the storage device 124, the database 3200, a user file 1200, a directory 2200, management information files 1100 and 2100, and a log file 3100 are stored, and these files are managed by the distributed file system 510 constructed by the distributed file system program 413.

FIG. 2B is an illustrative diagram of containerization of the program in the CPF 100 of the file storage system according to the embodiment. Hereinafter, the containerization of the program in the CPF of the embodiment will be described based on the configuration example illustrated in FIG. 2A. The above-described container infrastructure allocates, as resources, an area of the memory 112 required for containerization to the programs 411 to 415 to be operated, and then containerizes the programs 411 to 415 and provides containers 201 to 205 to the client 600.

The container is a means of virtualization technology in an area of a computer or an operating system (OS), and virtualizes a program or an application that can be executed directly in a user space on a kernel of the OS. The containerized program or application can function using a normal OS system call, and the container does not require a virtualized guest OS. That is, the client 600 can use a program or an application of the CPF regardless of its own OS and without using special emulation software or the like.

FIG. 2C is a diagram illustrating another example of the schematic configuration of the CPF of the file storage system according to the embodiment.

In this example, the CPF 100 is provided with a CPF server 101 that is a physical server, and a plurality of CPF virtual nodes 110′ as Virtual Machines are operated in the CPF server 101. The plurality of CPF virtual nodes 110′ are realized by sharing hardware resources such as the processor 111, the cache 113, and the interfaces (1/F) 114 and 115 in the CPF server 101, dividing a use area of the memory 112, and allocating the area to each of the virtual nodes, storing the various programs in the memory 112, and executing the programs. Because a configuration and operation of the CPF virtual node are the same as those of the CPF node 110 according to the embodiment of FIG. 2A, description thereof will be omitted. A plurality of CPF servers 101 may be provided according to the number of processing and a load of the file operation.

FIG. 2D is a diagram illustrating an image of an operation of the program in the CPF 100 of the file storage system according to the embodiment. FIG. 2D illustrates a program that is executed in the three CPF nodes 110-1, 110-2, and 110-3 and the storage system 120. As described above, the program to be executed by each CPF node 110 is selected from the various programs stored in the memory 112 of each node by the management terminal 700, and is set and registered in the container management data 416.

In FIG. 2D, the application program 411, the IO Hook program 412, and the distributed file system program 413 are executed in the CPF node 110-1, and the file virtualization program 415 and the distributed file system program 413 are executed in the CPF node 110-2. The distributed file system program 413 is executed in the CPF node 110-3. Further, in the storage system 120, the distributed file system 510 is executed.

In the present embodiment, (1) the application program 411 and the IO Hook program 412 are executed as a pair in the same the CPF node 110. As already described, because the IO Hook program 412 provides a virtual file system to the application program 411 and extracts the information on IO processing for the file from the system call issued by the application program 411, it is preferable that the IO Hook program 412 is executed together in the CPF node 110 in which the application program 411 is executed.

In relation to condition (1), when the management terminal 700 sets and registers an execution program in the container management data 416, the management terminal 700 may automatically set and register the IO Hook program 412 for the CPF node 110 in which the application program 411 has been registered.

Further, in the present embodiment, (2) the IO Hook program 412 and the file virtualization program 415 are executed on different CPF nodes 110. Although details of an operation will be described below, the load of the processor is large due to data communication with the OBJS 200, which is the backup destination of the files stored in the CPF 100, via the network 30 when the files in the storage device 124 are migrated, stubbed, or restored in the file virtualization program 415. On the other hand, the IO Hook program 412 monitors the system call according to the file operation request issued by the application program 411 while providing a virtual file system to the application program 411, and a program execution frequency tends to increase, resulting in a heavy load of the processor. When the IO Hook program 412 and the file virtualization program 415 are executed in the same node, a load of the processor for the execution of the file virtualization program 415 also increases as the execution frequency of the IO Hook program 412 increases, a delay in each processing of the migration, the stubbing, or the restoration, a discrepancy with resultant updated data, or the like occurs, and there is concern that reliability of file data may be affected.

In relation to condition (2), when the management terminal 700 sets and registers the execution program in the container management data 416, the file virtualization program 415 may be unable to be selected for the CPF node 110 in which the IO Hook program 412 has been registered.

Further, although the distributed file system program 413 is executed in each CPF node 110, one of these may be used as a master and the others may be operated as slaves. For example, when the distributed file system program 413 of the CPF node 110-3 is used as the master, system calls of the file operations concerning the distributed file system 510 received by the other CPF nodes 110-1 and 110-2 are transferred from the distributed file system programs 413 of the other CPF nodes 110-1 and 110-2, and the file operations are executed by the distributed file system program 413 of the master. It is possible to distribute a load of each CPF node 110 and concentrate resources on executhe tion of other programs by allowing the distributed file system program of the master to perform a centralized file operation in this way.

FIG. 2D illustrates a case in which there are three CPF nodes 110, but the number of CPF nodes 110 is not limited thereto. Further, a combination of each CPF node 110 and an operating program is not limited to an example of FIG. 2D as long as the above conditions (1) and (2) are satisfied.

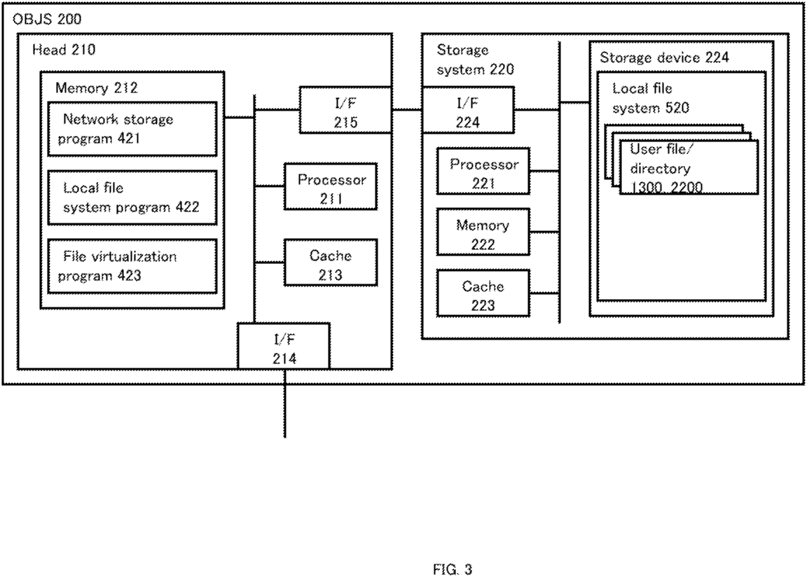

FIG. 3 is a diagram illustrating an example of a schematic configuration of the OBJS 200 of the file storage system 1 according to the embodiment.

The OBJS 200 includes a head 210 as a controller and a storage system 220.

The head 210 includes a processor 211 that performs entire operation control of the head 210 and the OBJS 200, a memory 212 that stores programs and data used for the operation control of the processor 211, a cache 213 that temporarily stores data written from the CPF 100 or data read from the storage system 220, an interface (I/F) 214 that performs communication with the sites 10-1 and 10-2, and an interface (I/F) 215 that performs communication with storage system 220.

The storage system 220 also includes a processor 221 that performs operation control of the storage system 220, a memory 222 that stores programs and data used for the operation control of the processor 221, a cache 223 that temporarily stores data written from the head 210 or data read from the storage device 224, and an interface (I/F) 225 that performs communication between the storage device 224 in which various files have been stored and the head 210.

A network storage program 421, a local file system program 422, and a file virtualization program 423 are stored in the memory 212.

The network storage program 421 receives various requests from the CPF 100 and processes protocol included in the requests.

The local file system program 422 provides a file system to the CPF 100. The file system program to be used is not limited to the local file system program 422, and a distributed file system may be used.

The file virtualization program 423 cooperates with the file virtualization program 415 of the CPF node 110 to migrate, stub, or restore the files in the storage device 124 of the CPF 100.

A user files 1200 and a directory 2200 are stored in the storage device 224, and these files are managed by a local file system 520 constructed by the local file system program 422.

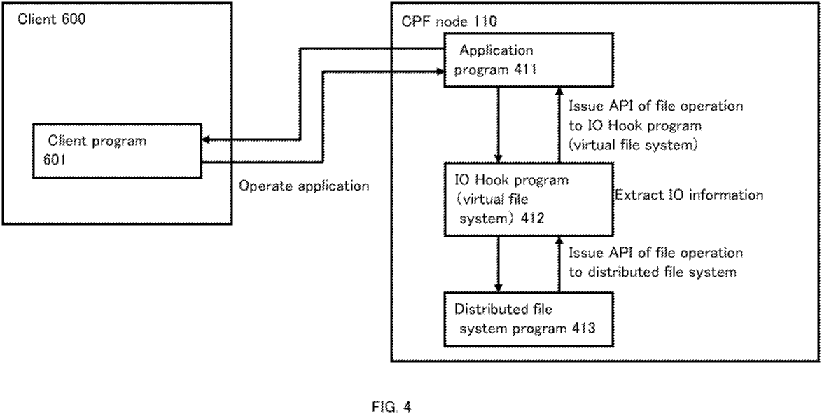

FIG. 4 is a diagram illustrating a function of the IO Hook program 412 of the file storage system 1 according to the embodiment. In FIG. 4, a case in which the application program 411, the IO Hook program 412, and the distributed file system program 413 operate in one CPF node 110 will be described for simplicity brevity of description.

The client 600 has a client program 601. The client program 601 is software for communicating with the application program 411 of the CPF 100 in response to a request of the client 600, and requests the CPF node 110 to perform a file operation through an operation of the application in a protocol of the CPF 100. The client program 601 is, for example, a remote access application or WWW (World Wide Web) browser software (when the protocol of CPF 100 is the Internet).

In the CPF node 110, the application program 411 performs a file operation with respect to a virtual file system that is provided by the IO Hook program 412 in response to the request. As will be described below, the virtual file system imitates the distributed file system 510 that is provided by the distributed file system program 413, and through such control, the IO Hook program 412 can recognize a system call by receiving the issuance of the system call of a file operation assuming the distributed file system 510 from the application program 411. Further, as already described, in the present embodiment, the application program 411 and the IO Hook program 412 are each containerized by the container infrastructure, are provided to the client 600, and are operated independently without affecting each other’s operating environment or specifications.

When the application program 411 issues the system call to the virtual file system provided by the IO Hook program 412, the IO Hook program 412 extracts the information on IO processing for the file from an API for a file operation with respect to the virtual file system, performs the processing for updating the file virtualization management information, and outputs the log. An extraction target for the information on IO processing is not limited to the system call, and may be, for example, a unique API provided by the distributed file system 510. After the information on IO processing is extracted, the I0 Hook program 412 outputs the API of the file operation with respect to the virtual file system issued by the application program 411 to the distributed file system 510, so that a desired file operation is performed with respect to the distributed file system 510.

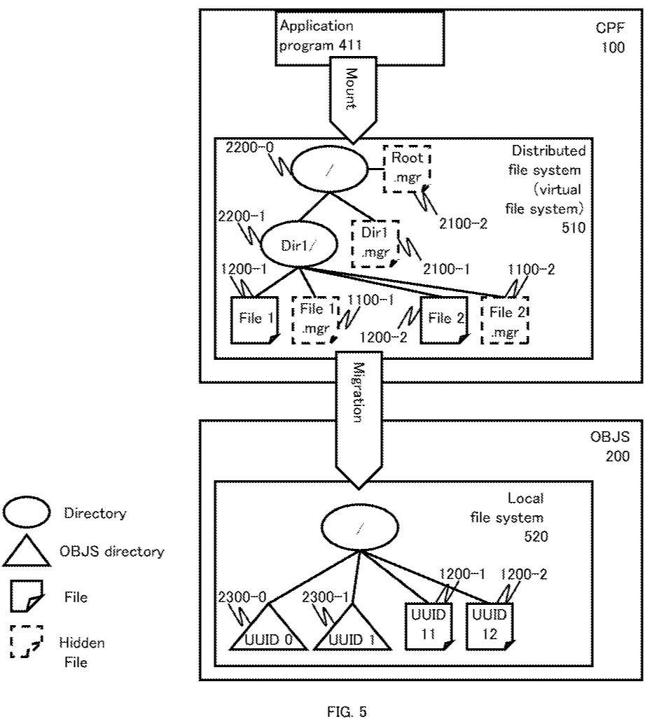

FIG. 5 is a diagram illustrating a file system that is provided by the file storage system 1 according to the embodiment.

As described above, the distributed file system 510 is constructed in (the storage system 120 of) the CPF 100, and the distributed file system 510 has a root directory 2200-0 and a directory 2200-1 as an example. The respective directories 2200-0 and 2200-1 include management information files 2100-1 and 2100-2, respectively. Files 1200-1 and 1200-2 are stored in the directory 2200-1 as an example. Further, management information files 1100-1 and 1100-2 of these files 1200-1 and 1200-2 are stored in the directory 2200-1.

The virtual file system provided to the application program 411 by the IO Hook program 412 has the similar configuration as the distributed file system 510 described above. The virtual file system may also be provided with the stubbed files, that is, files backed up by the OBJS 200 and deleted from the distributed file system 510, in addition to the distributed file system 510. The client 600 can perform various file operations through the application program 411 by mounting the virtual file system on the application program 411 when the container infrastructure starts the application program 411. However, the management information file does not appear on the virtual file system and cannot be operated because the IO Hook program 412 filters information.

The local file system 520 is also built in the OBJS 200. The local file system 520 does not have a tiered structure, and all directories 2300-0 and 2300-1 and files 1200-1 and 1200-2 are disposed under a root directory. In the OBJS 200, the respective directories 2300-0 and 2300-1 and files 1200-1 and 1200-2 are uniquely identified by a UUID (Universally Unique Identifier).

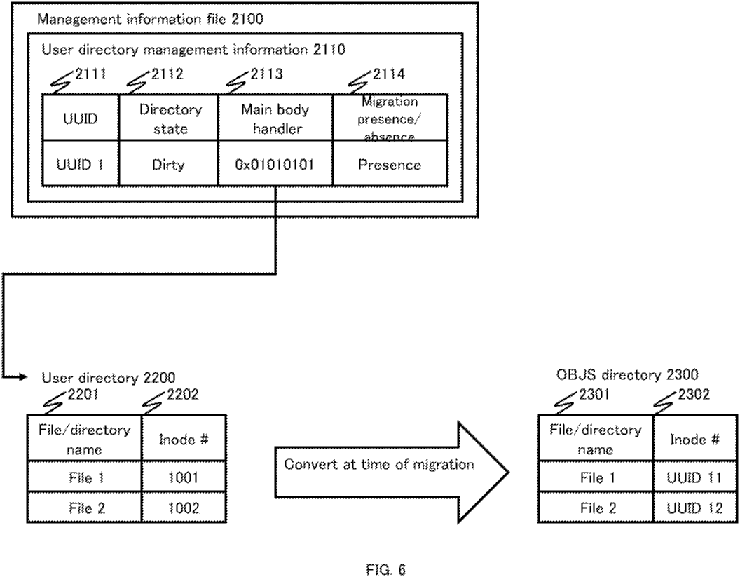

FIG. 6 is a diagram illustrating an example of a management information file 2100 of the file storage system 1 according to Embodiment 1.

The management information file 2100 includes user directory management information 2110. The user directory management information 2110 includes an entry for each UUID. The respective entries are a UUID 2111 imparted to the user directory 2200, a directory state 2112 of the user directory 2200, a main body handler 2113 of the user directory 2200, and migration presence/absence 2114.

The directory state 2112 is a value indicating whether or not the user directory 2200 has been updated from the previous backup, and Dirty is a value indicating that the file has been updated. The main body handler 2113 is a value for uniquely identifying the user directory 2200, and is a value that can be used to designate the user directory 2200 as an operation target through a system call. For the main body handler 2113, a value that does not change between the creation and deletion of the user directory 2200 is used. The migration presence/absence 2114 is a value indicating whether or not the user directory 2200 has been backed up even once.

The user directory 2200 includes a file/directory name 2201 and an Inode number (#) 2202. The example illustrated in FIG. 6 is the directory (dirl) 2200-1 in FIG. 5, and two files (File 1 and File 2) are stored in this directory 2200-1. The Inode number 2202 is an Inode number uniquely imparted to the respective files (File 1 and File 2) .

An OBJS directory 2300 has a file/directory name 2301 and an Inode number (#) 2302. The file/directory name 2301 is the same as the file/directory name 2201 of the user directory 2200, but the Inode number 2302 is rewritten to UUID at the time of migration from the CPF 100 to the OBJS 200. This is because the Inode number is uniquely defined only in the CPF 100, and it is necessary to assign a UUID uniquely defined in the OBJS 200 at the time of migration.

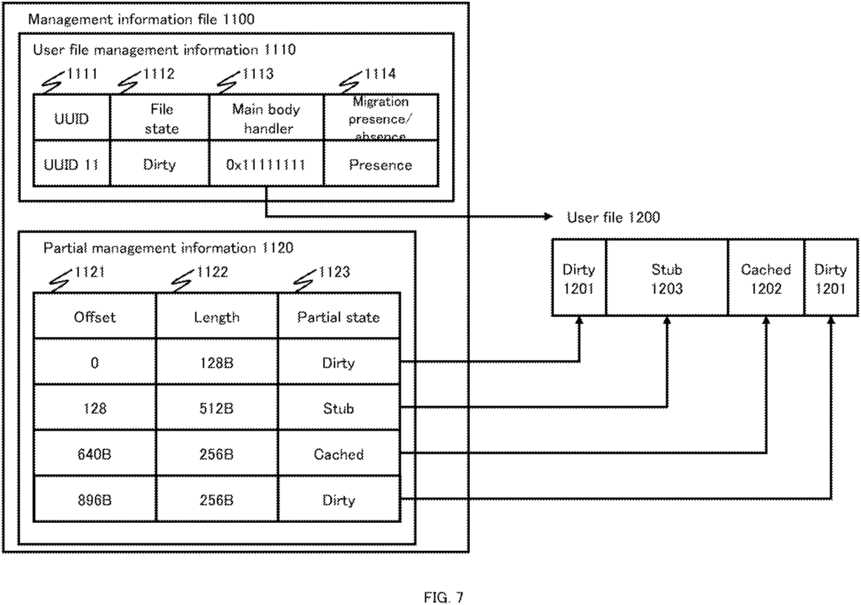

FIG. 7 is a diagram illustrating another example of the management information file 1100 of the file storage system 1 according to the embodiment.

The management information file 1100 includes user file management information 1110 and partial management information 1120.

The user file management information 1110 includes an entry for each UUID. Each entry is a UUID 1111 imparted to the user file 1200, a file state 1112 of the user file 1200, a main body handler 1113 of the user file 1200, and the migration presence/absence 2114.

The partial management information 1120 is created for each user file 1200. The partial management information 1120 includes an offset 1121, a length 1122, and a partial state 1123. The offset 1121 indicates a start position of the update processing when the user file 1200 has been subjected to partial update processing, the length 1122 indicates how much data length has been updated from a position of the offset 1121, and the partial state 1123 indicates what kind of update processing has been performed. Here, Dirty 1201 indicates that the file has been updated since previous backup processing, Stub 2203 indicates that the file has been erased from the local (that is, CPF 100) after the backup processing, and Cached 2202 indicates that there is data in local and there is also a backup.

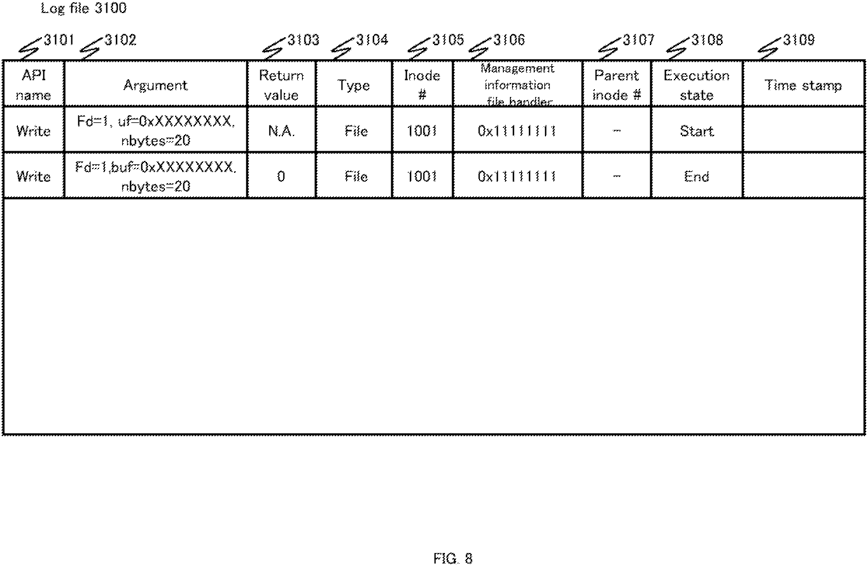

FIG. 8 is a diagram illustrating an example of the log file 3100 of the file storage system 1 according to the embodiment.

The log file 3100 includes an API name 3101, an argument 3102, a return value 3103, a type 3104, an Inode number 3105, a management information file handler 3106, a parent Inode number 3107, an execution state 3108, and a time stamp 3109. Each line of the log file 3100 is created each time there is a system call from the application program 411 to the virtual file system provided by the IO Hook program 412.

The API name 3101 indicates a type of system call, and roughly values of write, read, open, and close are stored. The argument 3102 is an argument of the system call and roughly has a file descriptor, a file operation start position, and a data size. The return value 3103 is a value that is returned from the distributed file system 510 as a result of the system call, and N.A. indicates that there is no return value yet because the system call is being executed, and 0 indicates normal execution. In addition thereto, a value determined by the distributed file system 510 is stored. The type 3104 is a value indicating whether a target of the system call is a file or a directory. The Inode number is an Inode number of a file or the like that is the target of the system call. The management information file handler 3106 is a value for uniquely specifying the file or the like that is the target of the system call, and is a value that can be used for operation target designation in a file or directory operation in the system call. The management information file handler 3106 is not changed from creation to deletion of files or directories. The parent Inode number 3107 is an Inode number of a higher-level (parent) directory of the file or the like that is the target of the system call. This is because, when the file or the directory has been moved or deleted according to the system call, a parent directory needs to be identified as a backup processing target. In the execution state 3108, a value indicating an execution state of the system call is stored. The time stamp 3109 is a time when the system call has been called.

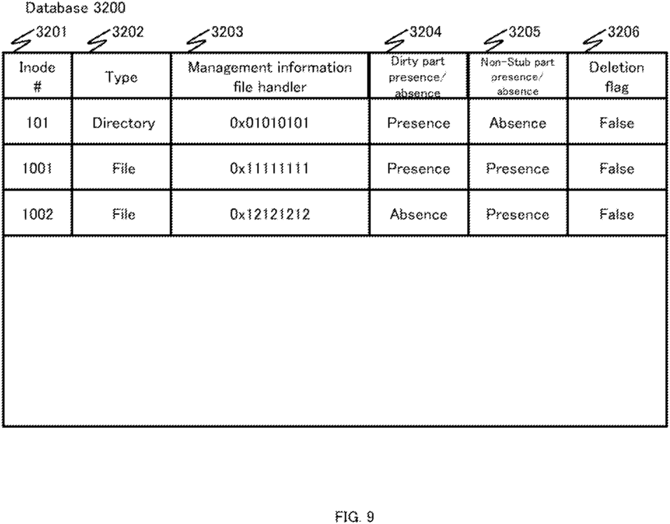

FIG. 9 is a diagram illustrating an example of the database 3200 of the file storage system 1 according to the embodiment.

The database 3200 includes an Inode number 3201, a type 3202, a management information file handler 3203, a Dirty part presence/absence 3204, a non-Stub part presence/absence 3205, and a deletion flag 3206. Each line of database 3200 is created for each directory and file in the distributed file system 510.

The Inode number 3201 is an Inode number of a directory or file. The type 3202 is a value indicating whether a file or a directory is identified by the Inode number 3201. The management information file handler 3203 is a value for uniquely specifying a target file or the like. In the Dirty part presence/absence 3204, a value indicating whether or not there is a Dirty part in the file stored in the directory or a part of the file itself is stored. In the non-Stub part presence/absence 3205, a value indicating whether or not there is a rewritten part in the data after previous backup processing is stored. In the deletion flag 3206, a value indicating whether or not the file stored in the directory or the file itself has been deleted is stored.

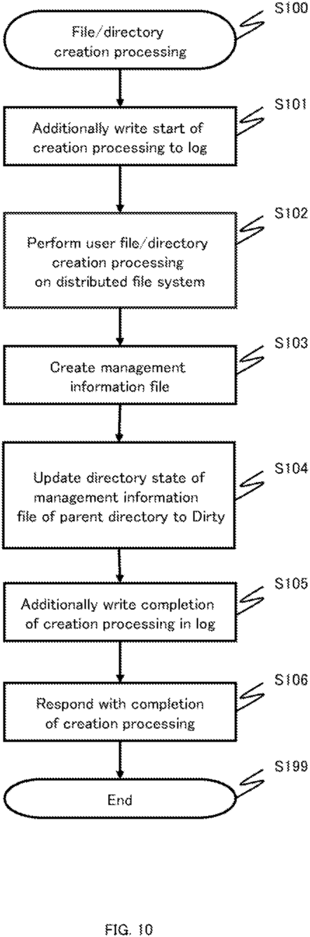

Then, an operation of the file storage system 1 of the present embodiment will be described with reference to the flowcharts of FIGS. 10 to 21.

FIG. 10 is a flowchart illustrating an example of a file/directory creation processing of the file storage system 1 according to the embodiment.

When the file/directory creation processing starts (step S100), the IO Hook program 412 first additionally writes the start of the creation processing to the log file 3100 (step S101).

Then, the IO Hook program 412 performs a processing of creating user file 1200/directory 2200 based on the system call from the application program 411 (step S102) . Then, the IO Hook program 412 creates the management information files 1100 and 2100 (step S103). Then, the IO Hook program 412 updates the directory state 2112 of the management information file 2100 of a parent directory of the file/directory that is a creation target to Dirty (step S104).

The IO Hook program 412 additionally writes the completion of the creation processing to the log file 3100 (step S105), and responds to the application program 411 with the completion of the creation processing (step S106).

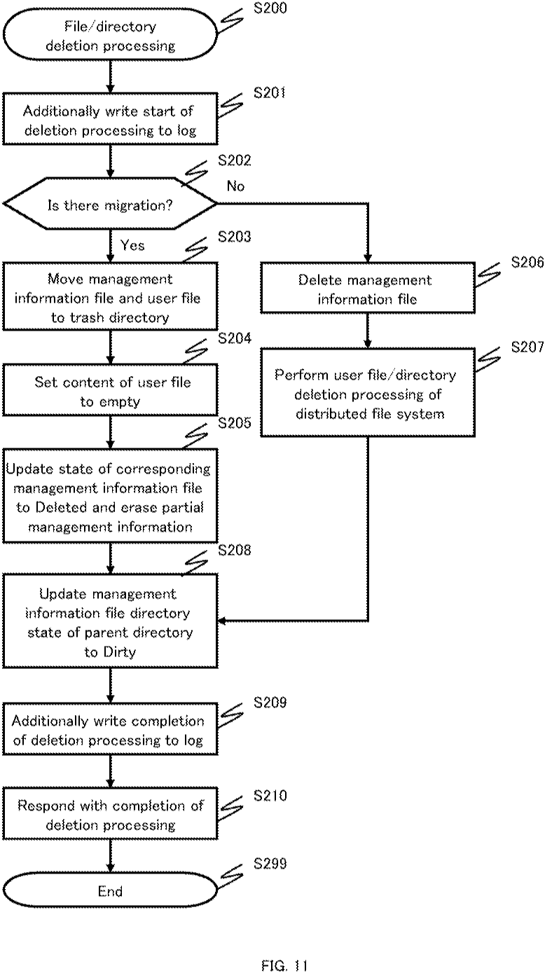

FIG. 11 is a flowchart illustrating an example of_file/directory deletion processing of the file storage system 1 according to the embodiment.

When the file/directory deletion processing starts (step S200), the IO Hook program 412 first additionally writes the start of the deletion processing to the log file 3100 (step S201).

Then, the IO Hook program 412 determines whether or not there is a migration in the file/directory that is a deletion target (step S202) . The presence/absence of the migration can be confirmed through presence/absence 1114 and 2114 of the migration of the management information files 1100 and 2100. When the determination is affirmative (YES in step S202), the program proceeds to step S203, and when the determination is negative (NO in step S202), the program proceeds to step S206.

In step S203, the IO Hook program 412 moves the management information files 1100 and 2100 and the user file 1200 to a trash directory, and then the IO Hook program 412 sets the content of the user file 1200 to Empty (step S204) . The IO Hook program 412 updates the file state 1112/directory state 2112 of the corresponding management information files 1100 and 2100 to Deleted, and erases the partial management information 1120 (step S205).

On the other hand, in step S206, the IO Hook program 412 erases the management information files 1100 and 2100, and then executes processing for deleting the user file 1200/user directory 2200 (step S207).

Then, the IO Hook program 412 updates the directory state 2112 of the management information file 2100 of the parent directory of the file/directory that is a creation target to Dirty (step S208). The IO Hook program 412 additionally writes the completion of the deletion processing to the log file 3100 (step S209), and responds to the application program 411 with the completion of the deletion processing (step S210).

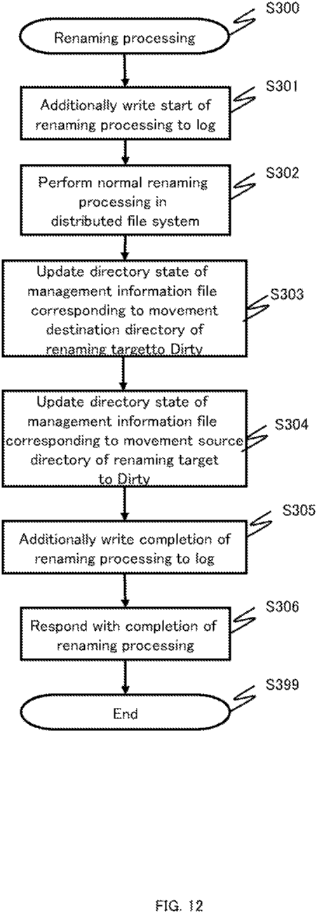

FIG. 12 is a flowchart illustrating an example of renaming processing of the file storage system 1 according to the embodiment.

When the renaming processing starts (step S300), the IO Hook program 412 first additionally writes the start of the renaming processing to the log file 3100 (step S301).

Then, the IO Hook program 412 performs normal renaming processing (step S302). Then, the IO Hook program 412 updates the directory state 2112 of the management information file 2100 corresponding to a movement destination directory that is a renaming target to Dirty (step S303), and the IO Hook program 412 updates the directory state 2112 of the management information file 2100 corresponding to the movement destination directory of the name target to Dirty (step S304).

The IO Hook program 412 additionally writes the completion of the renaming processing to the log file 3100 (step S305), and responds to the application program 411 with the completion of the renaming processing (step S306).

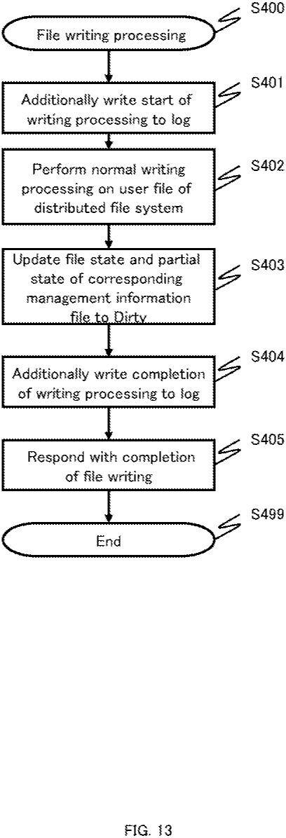

FIG. 13 is a flowchart illustrating an example of the file writing processing of the file storage system 1 according to the embodiment.

When the file writing processing starts (step S400), the IO Hook program 412 first additionally writes the start of the writing processing to the log file 3100 (step S401).

Then, the IO Hook program 412 performs normal writing processing on the user file 1200 (step S402). Then, the IO Hook program 412 updates the file state 1112 of the corresponding management information file 1100 to Dirty (step S403).

The IO Hook program 412 additionally writes the completion of the writing processing to the log file 3100 (step S404), and responds to the application program 411 with the completion of the writing processing (step S405).

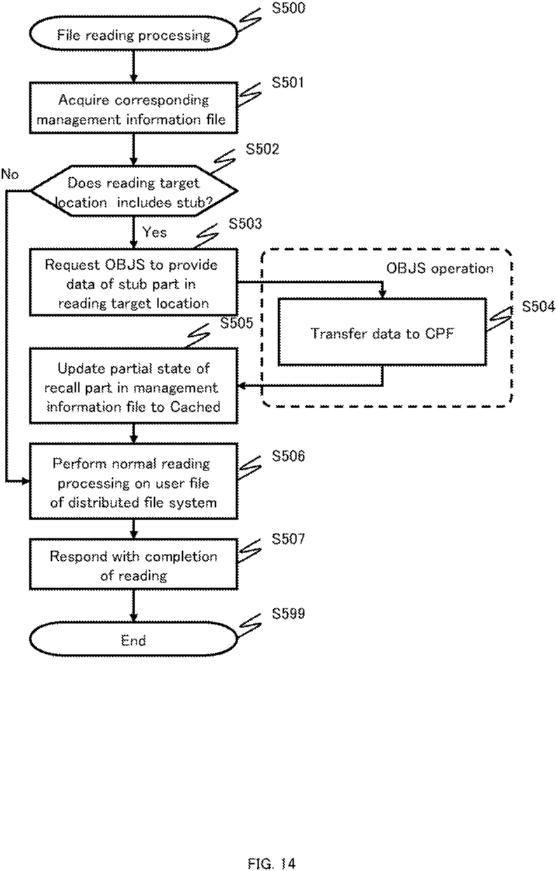

FIG. 14 is a flowchart illustrating an example of file reading processing of the file storage system 1 according to the embodiment.

When the file reading processing starts (step S500), the IO Hook program 412 first acquires the corresponding management information file 1100 (step S501).

Then, the IO Hook program 412 determines whether or not a reading target location includes a stubbed portion (step S502). When the determination is affirmative (YES in step S502), the program proceeds to step S503, and when the determination is negative (NO in step S502), the program proceeds to step S506.

In step S503, the IO Hook program 412 requests the OBJS 200 to provide data of the stubbed portion in the reading target location. The file virtualization program 423 of the OBJS 200 transfers the data to the CPF 100 based on a request from the IO Hook program 412 (step S504) .

Then, the IO Hook program 412 updates a recall part in the management information file 1100, that is, the partial state 1123 of the data transferred from the OBJS 200 to Cached (step S505).

Then, the IO Hook program 412 performs a normal reading processing on the user file 1200 (step S506), and responds to the application program 411 with the completion of the reading processing (step S507) .

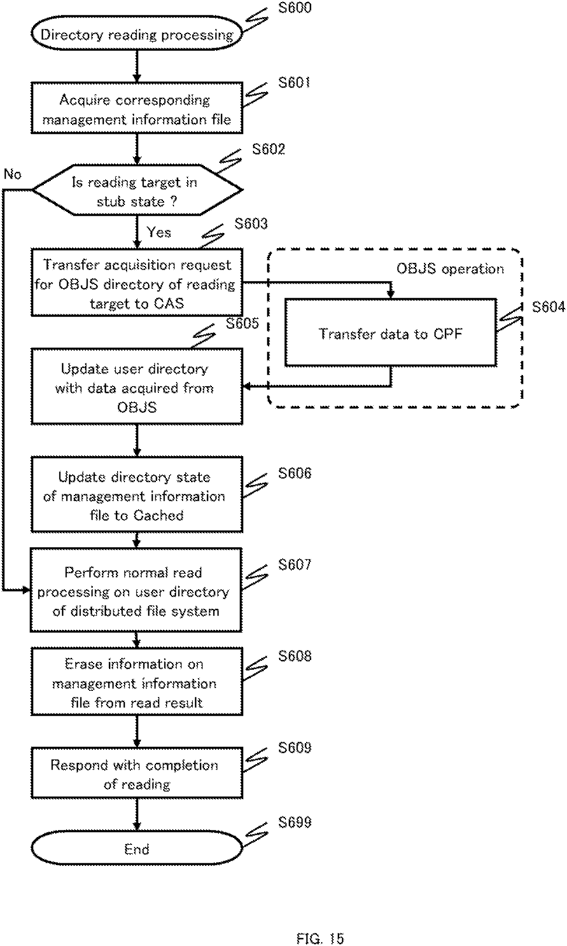

FIG. 15 is a flowchart illustrating an example of the directory reading processing of the file storage system 1 according to the embodiment.

When the directory reading processing starts (step S600), the IO Hook program 412 first acquires the corresponding management information file 2100 (step S601).

Then, the IO Hook program 412 determines whether or not the directory is stubbed in the reading target (step S602). When the determination is affirmative (YES in step S602), the program proceeds to step S603, and when the determination is negative (NO in step S602), the program proceeds to step S607.

In step S603, the IO Hook program 412 transfers an acquisition request for the OBJS directory 2300 which is a reading target to the OBJS 200. The file virtualization program 423 of the OBJS 200 transfers the data to the CPF 100 based on the request from the IO Hook program 412 (step S604).

Then, the IO Hook program 412 updates the user directory 2200 with the data acquired from the OBJS 200 (step S605), and updates the directory state 2112 of the management information file 2100 to Cached (step S606).

The IO Hook program 412 performs normal reading processing on the user directory 2200 (step S607), and erases information on the management information file 2100 from a read result so that the management information file 2100 cannot be seen from the client 600 (step S608), and responds to the application program 411 with the completion of the reading processing (step S609).

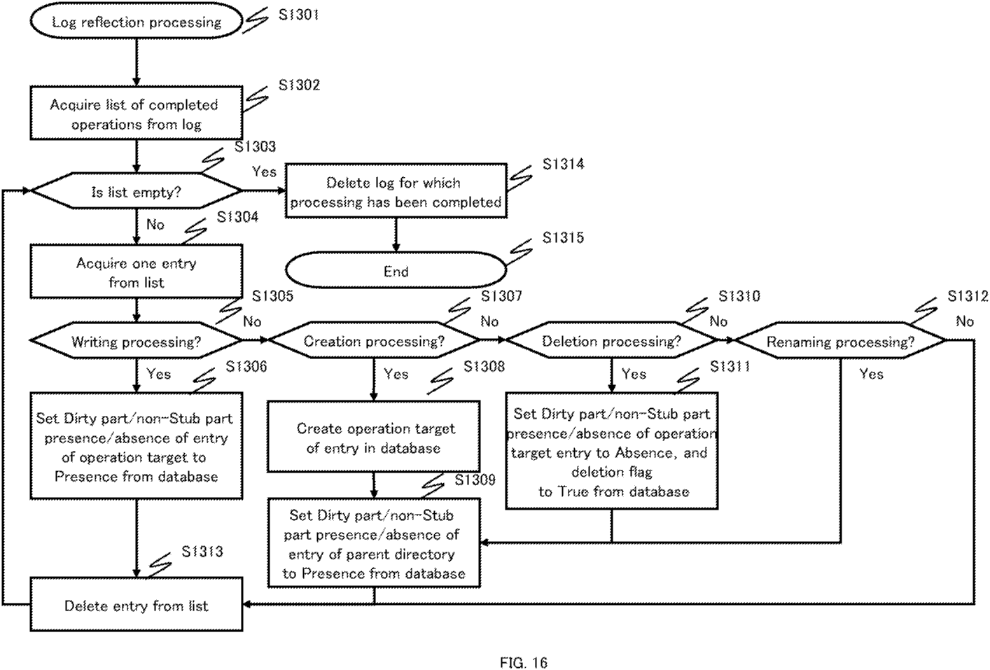

FIG. 16 is a flowchart illustrating an example of the log reflection processing of the file storage system 1 according to the embodiment.

When the log reflection processing starts (step S1301), the file virtualization program 415 refers to the execution state 3108 of the log file 3100 to acquire a list of completed operations from the log file 3100 (step S1302).

Then, the file virtualization program 415 determines whether or not the list acquired in step S1302 is empty (step S1303). Accordingly, when the determination is affirmative (YES in step S1303), the program proceeds to step S1314, and when the determination is negative (NO in step S1303), the program proceeds to step S1304.

In step S1304, the file virtualization program 415 acquires one entry from the list acquired in step S1302. Then, the file virtualization program 415 determines whether or not the entry acquired in step S1304 is writing processing (step S1305). When the determination is affirmative (YES in step S1305), the program proceeds to step S1306, and when the determination is negative (NO in step S1305), the program proceeds to step S1307.

In step S1306, the file virtualization program 415 sets each of the Dirty part presence/absence 3204 and the non-Stub part presence/absence 3205 of the operation target entry of the database 3200 to Presence.

In step S1307, the file virtualization program 415 determines whether or not the entry acquired in step S1304 is creation processing. When the determination is affirmative (YES in step S1307), the program proceeds to step S1308, and when the determination is negative (NO in step S1307), the program proceeds to step S1310.

In step S1308, the file virtualization program 415 creates the operation target entry of the database 3200, sets each of the Dirty part presence/absence 3204 and the non-Stub part presence/absence 3205 of the created entry to Presence, and sets a value of the deletion flag 3206 to False. Further, the file virtualization program 415 sets the Dirty part presence/absence 3204 and the non-Stub part presence/absence 3205 of the entry of the parent directory of an operation target of the database 3200 to Presence (step S1309).

In step S1310, the file virtualization program 415 determines whether or not the entry acquired in step S1304 is deletion processing. When the determination is affirmative (YES in step S1310), the program proceeds to step S1311, and when the determination is negative (NO in step S1310), the program proceeds to step S1312.

In step S1311, the file virtualization program 415 sets each of the Dirty part presence/absence 3204 and the non-Stub part presence/absence 3205 of the operation target entry of the database 3200 to Absence, and further sets the deletion flag 3206 to True.

In step S1312, the file virtualization program 415 determines whether or not the entry acquired in step S1304 is renaming processing. When the determination is affirmative (YES in step S1312), the program proceeds to step S1309, and when the determination is negative (NO in step S1312), the program proceeds to step S1313.

In step S1313, the file virtualization program 415 deletes the entry from the list acquired in step S1302.

On the other hand, in step S1314, the log of which the processing has been completed by the file virtualization program 415 is deleted.

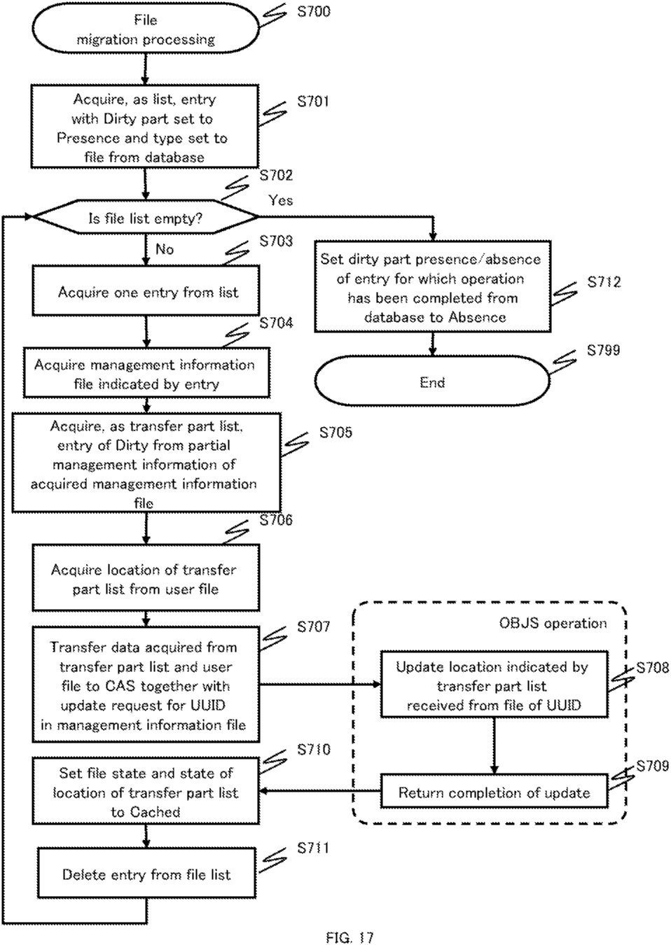

FIG. 17 is a flowchart illustrating an example of file migration processing of the file storage system according to the embodiment.

When the file migration processing starts (step S700), the file virtualization program 415 acquires, as a list, entries in which the Dirty part presence/absence 3204 is set to Presence and the type 3202 is set to a file from the database 3200 (step S701).

Then, the file virtualization program 415 determines whether or not the file list acquired in step S701 is empty (step S702) . As a result, when the determination is affirmative (YES in step S702), the program proceeds to step S712, and when the determination is negative (NO in step S702), the program proceeds to step S703.

In step S703, the file virtualization program 415 acquires one entry from the list acquired in step S701. Then, the file virtualization program 415 acquires the management information file 1100 indicated by the entry acquired in step S703 (step S704). Then, the file virtualization program 415 acquires the entry of Dirty as a transfer part list from the partial management information 1120 of the management information file 1100 acquired in step S704 (step S705), and acquires a corresponding location of the acquired transfer part list from the user file 1200 (step S706).

Then, the file virtualization program 415 transfers the transfer part list acquired in step S705 and the data from the user file 1200 acquired in step S706 to the OBJS 200 together with the update request to the UUID 1111 in the management information file 1100 (step S707).

The file virtualization program 423 of the OBJS 200 updates the location indicated by the transfer part list received in step S707 from the user file 1200 in the OBJS 200 identified by the UUID (step S708), and returns the completion of the update to the CPF 100 (step S709).

The file virtualization program 415 sets the file state 1112 of the management information file 1100 and the partial state 1123 of the corresponding location of the transfer part list to Cached (step S710), and deletes the entry from the file list acquired in step S701 (step S711) .

On the other hand, in step S712, the file virtualization program 415 sets the Dirty part presence/absence 3204 of the entry of which the operation has been completed from the database 3200 to Absence.

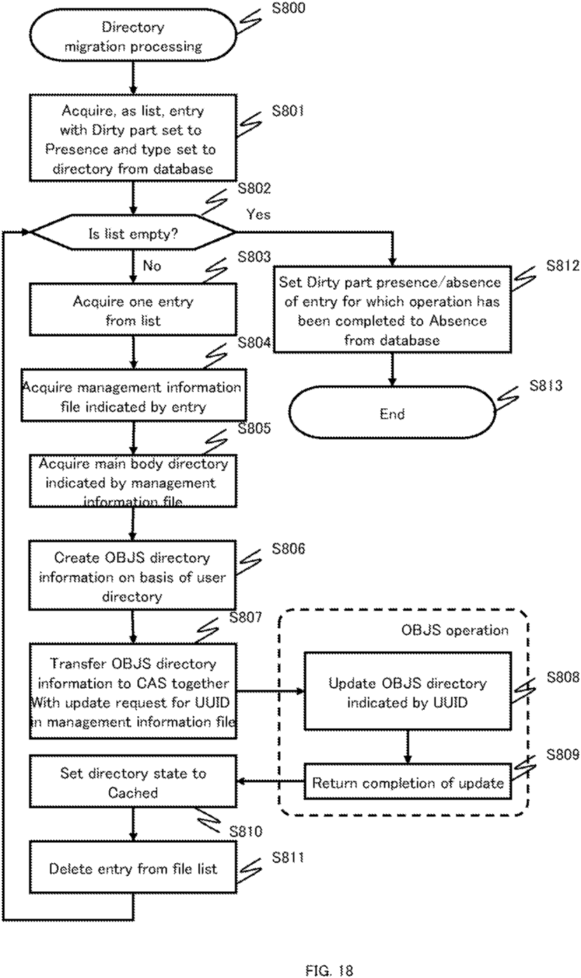

FIG. 18 is a flowchart illustrating an example of directory migration processing of the file storage system 1 according to the embodiment.

When the directory migration processing starts (step S800), the file virtualization program 415 acquires entries in which the Dirty part presence/absence 3204 is set to Presence and the type 3202 is the directory as a list from the database 3200 (step S801).

Then, the file virtualization program 415 determines whether or not the file list acquired in step S801 is empty (step S802). As a result, when the determination is affirmative (YES in step S802), the program proceeds to step S812, and when the determination is negative (NO in step S802), the program proceeds to step S803.

In step S803, the file virtualization program 415 acquires one entry from the list acquired in step S801. Then, the file virtualization program 415 acquires the management information file 2100 indicated by the entry acquired in step S803 (step S804). Then, the file virtualization program 415 acquires the user directory 2200 indicated by the management information file 2100 acquired in step S804 (step S805), and generates information on the OBJS directory 2300 based on the acquired user directory 2200 (step S806).

Then, the file virtualization program 415 transfers the information on the OBJS directory 2300 generated in step S806 to the OBJS 200 together with the update request to the UUID 2111 in the management information file 2100 (step S807).

The file virtualization program 423 of the OBJS 200 updates the OBJS directory 2300 in the OBJS 200 identified by the UUID (step S808), and returns the completion of the update to the CPF 100 (step S809).

The file virtualization program 415 sets the directory state 2112 of the management information file 2100 to Cached (step S810), and deletes the entry from the file list acquired in step S801 (step S811) .

On the other hand, in step S812, the file virtualization program 415 sets the Dirty part presence/absence 3204 of the entry of which the operation has been completed from the database 3200 to Absence.

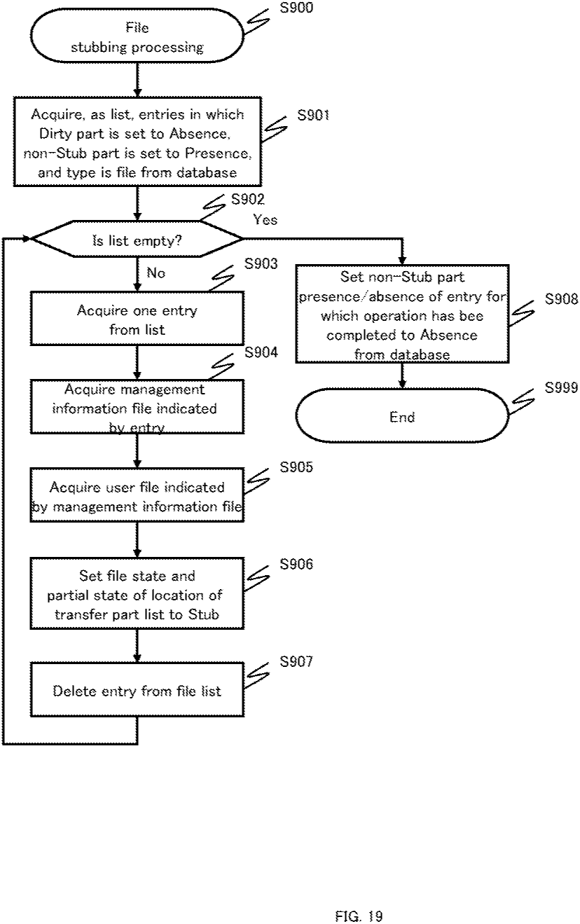

FIG. 19 is a flowchart illustrating an example of a file stubbing processing of the file storage system 1 according to the embodiment.

When the file stubbing processing starts (step S900), the file virtualization program 415 acquires, as a list, the entries in which the Dirty part presence/absence 3204 is set to Absence and the type 3202 is a file from the database 3200 (step S901).

Then, the file virtualization program 415 determines whether or not the file list acquired in step S901 is empty (step S902) . Accordingly, when the determination is affirmative (YES in step S902), the program proceeds to step S908, and when the determination is negative (NO in step S902), the program proceeds to step S903.

In step S703, the file virtualization program 415 acquires one entry from the list acquired in step S901. Then, the file virtualization program 415 acquires the management information file 1100 indicated by the entry acquired in step S703 (step S904). Then, the file virtualization program 415 acquires the user file 1200 indicated by the management information file 1100 acquired in step S904 (step S905).

The file virtualization program 415 sets the file state 1112 of the management information file 1100 and the partial state 1123 of the corresponding location of the transfer part list to Stub (step S906), and deletes the entry from the file list acquired in step S901 (step S907) .

On the other hand, in step S908, the file virtualization program 415 sets the non-Stub part presence/absence 3205 of the entry of which the operation has been completed from the database 3200 to Absence.

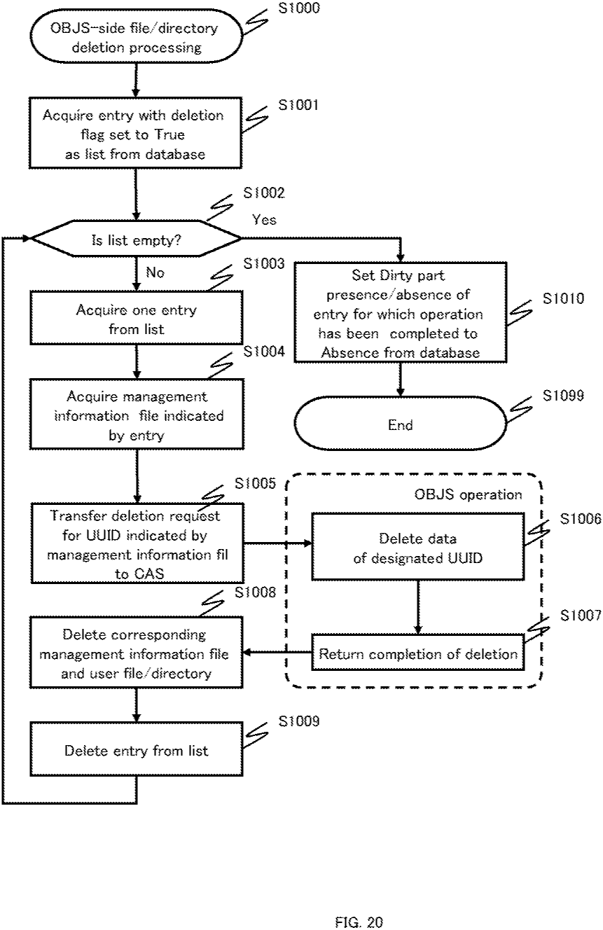

FIG. 20 is a flowchart illustrating an example of OBJS-side file/directory deletion processing of the file storage system 1 according to the embodiment.

When the OBJS-side file/directory deletion processing starts (step S1000), the file virtualization program 415 acquires, as a list, entries in which the deletion flag 3206 is True from the database 3200 (step S1001).

Then, the file virtualization program 415 determines whether or not the file list acquired in step S1001 is empty (step S1002). Accordingly, when the determination is affirmative (YES in step S1002), the program proceeds to step S1010, and when the determination is negative (NO in step S1002), the program proceeds to step S1003.

In step S1003, the file virtualization program 415 acquires one entry from the list acquired in step S1001. Then, the file virtualization program 415 acquires the management information files 1100 and 2100 indicated by the entry acquired in step S1003 (step S1004).

Then, the file virtualization program 415 transfers a deletion request for the UUID 1111 and 2111 indicated by the management information files 1100 and 2100 to the OBJS 200 (step S1005).

The file virtualization program 423 of the OBJS 200 deletes the user file 1200/user directory 2200 in the OBJS 200 identified by the UUID (step S1006), and returns the completion of the deletion to the CPF 100 (step S1007).

The file virtualization program 415 deletes the entry from the list acquired in step S1001 (step S1009).

On the other hand, in step S1010, the file virtualization program 415 sets the Dirty part presence/absence 3204 of the entry of which the operation has been completed from the database 3200 to Absence.

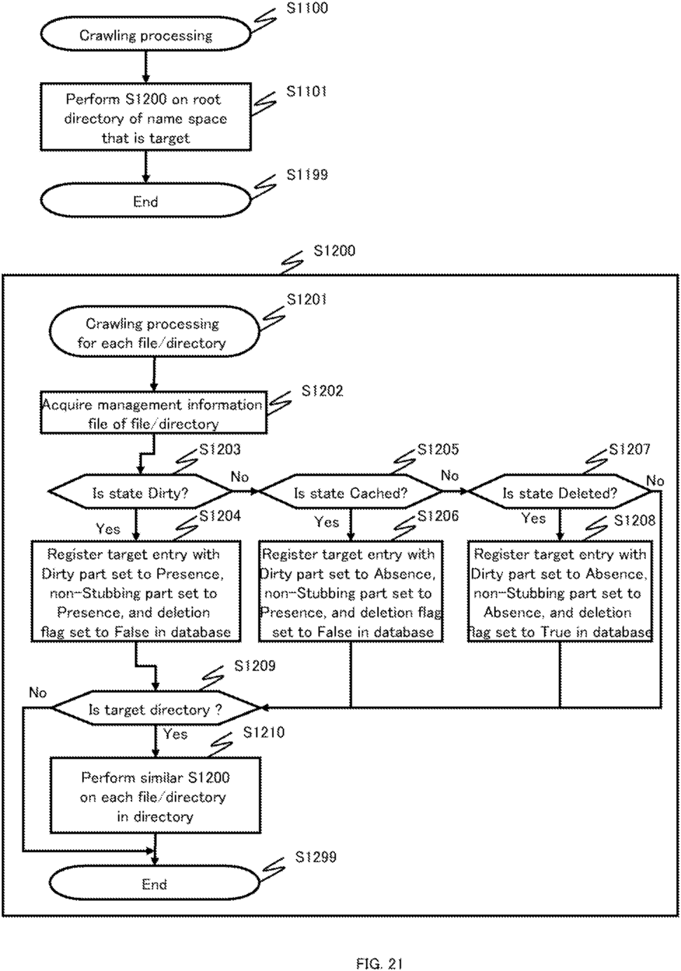

FIG. 21 is a flowchart illustrating an example of crawling processing of the file storage system 1 according to the embodiment.

When the crawling processing starts (step S1100), the file virtualization program 415 executes processing of step S1200 shown below for the root directory 2200 of the user file 1200/user directory 2200 that is a file virtualization target.

In step S1200, the file virtualization program 415 first acquires the management information files 1100 and 2100 of the user file 1200/user directory 2200 (step S1202).

Then, the file virtualization program 415 determines whether or not the file state 1112/directory state 2112 of the management information files 1100 and 2100 acquired in step S1202 is Dirty (step S1203). When the determination is affirmative (YES in step S1203), the program proceeds to step S1204, and when the determination is negative (NO in step S1203), the program proceeds to step S1205.

In step S1204, the target entry is registered in the database 3200, in which the Dirty part presence/absence 3204 is set to Presence, the non-Stub part presence/absence 3205 is set to Presence, and the deletion flag 3206 is set to False.

In step S1205, the file virtualization program 415 determines whether or not the file state 1112/directory state 2112 of the management information files 1100 and 2100 acquired in step S1202 is Cached. When the determination is affirmative (YES in step S1205), the program proceeds to step S1206, and when the determination is negative (NO in step S1205), the program proceeds to step S1207.

In step S1206, the target entry is registered in the database 3200, in which the Dirty part presence/absence 3204 is set to Absence, the non-Stub part presence/absence 3205 is set to Presence, and the deletion flag 3206 is set to False.

In step S1207, the file virtualization program 415 determines whether or not the file state 1112/directory state 2112 of the management information files 1100 and 2100 acquired in step S1202 are Deleted. When the determination is affirmative (YES in step S1207), the program proceeds to step S1208, and when the determination is negative (NO in step S1207), the program proceeds to step S1209.

In step S1208, the target entry is registered in the database 3200, in which the Dirty part presence/absence 3204 is set to Absence, the non-Stub part presence/absence 3205 is set to Absence, and the deletion flag 3206 is set to True.

In step S1209, the file virtualization program 415 determines whether or not a target of the crawling processing is a directory. When the determination is affirmative (YES in step S1209), the program proceeds to step S1210, and when the determination is negative (NO in step S1209), the program ends.

In step S1210, the processing of step S1200 is executed for each file/directory in the directory.

According to the present embodiment configured as described above, the CPF 100 of the file storage system 1 interrupts between a file operation request from the client 600 and call processing of the file system, and adds the update processing for the management information files 1100 and 2100, which are file state management information, based on input information or operation content with respect to the file system.

Therefore, according to the present embodiment, it is possible to easily provide the file virtualization function without being affected by an application that accesses the file system.

The CPF node 110 containerizes the application program 411 and the IO Hook program 412 and provides the application program 411 and the IO Hook program 412 to the client 600, and the application program 411 and the IO Hook program 412 operate independently without affecting each other’s operating environments or specifications. The IO Hook program 412 provides a virtual file system simulating the distributed file system 510 to the application program 411, and the application program 411 issues a system call for a file operation with respect to the virtual file system based on the request from the client 600. The IO Hook program 412 extracts the information on IO processing for the file from the issued system call for the file operation with respect to the virtual file system, performs the processing for updating the file virtualization management information, and outputs the log. Further, the IO Hook program 412 outputs the API of the file operation with respect to the virtual file system issued by the application program 411 to the distributed file system 510, so that the desired file operation is performed.

With such a configuration, because a type of application is not considered and creation or application modification for linking the IO Hook program to any application is not necessary, man-hours and labor for developing a file virtualization system can be reduced and the file virtualization function can be easily provided.

Further, according to the present embodiment, because the CPF node 110 suitable for execution can be appropriately selected and registered according to operation characteristics or a load situation of each program by selecting, setting, and registering the CPF node 110 that containerizes and executes respective programs such as the application program 411 and the IO Hook program 412, it is possible to distribute the load to a plurality of CPF nodes 110 while avoiding load concentration such as a file operation on a specific the CPF node 110.

The above-described embodiment describes the configuration in detail in order to explain the present invention in an easy-to-understand manner, and is not necessarily limited to the one including all the described configurations. Further, it is possible to add, delete, or replace a part of the configuration of each embodiment with other configurations.

Further, the above configurations, functions, processing units, processing means, and the like may be realized by hardware by designing some or all of these as an integrated circuit, for example. The present invention can also be realized by a software program code that realizes the functions of the embodiments. In this case, a storage medium on which the program code has been recorded is provided to a computer, and a processor included in the computer reads the program code stored in the storage medium. In this case, the program code itself read from the storage medium realizes the function of the above-described embodiment, and the program code itself and the storage medium in which the program code has been stored constitute the present invention. Examples of the storage medium for supplying such a program code include a flexible disk, a CD-ROM, a DVD-ROM, a hard disk, an SSD (Solid State Drive), an optical disc, a magneto-optical disc, a CD-R, a magnetic tape, a non-volatile memory card, and a ROM.

Further, the program code that realizes the functions described in the present embodiment can be implemented in a wide range of programs or script languages such as assembler, C/C++, perl, Shell, PHP, and Java (registered trademark).

In the above-described embodiment, control lines or information lines indicate things considered to be necessary for description, and all control lines and information lines are not necessarily indicated in a product. All configurations may be interconnected to each other.

What is claimed is:

1. A distributed file storage system comprising
a plurality of storage nodes that each provide a first file system, and
a first storage system in which files are stored by the first file system,
and being available a second storage system,
wherein each of the storage nodes includes
an application configured to issue an operation request for the file based on a request from a client,
a state information management unit configured to manage state management information having a state of the file stored therein and further to provide a virtual file system based on the first file system to the application, and
a file virtualization unit configured to manage the files stored in the first storage system and the second storage system,
the application performs a call processing for the virtual file system based on the operation request for the file,
the state information management unit outputs the operation request for the file to the first file system, and performs update processing on the state management information of the file based on input information or operation content with respect to the first file system related to the operation request,
the first file system processes the operation request for the file, and
the file virtualization unit performs management processing for the file between the first storage system and the second storage system based on the state management information.

2. The file storage system according to claim 1,
wherein the application, the state information management unit, and the file virtualization unit are containerized, and each of the applications and the units is executed in at least one of the storage nodes.

3. The file storage system according to claim 2, wherein the application and the state information management unit are executed in the same storage node.

4. The file storage system according to claim 2, wherein the state information management unit and the file virtualization unit are executed in different storage nodes.

5. The file storage system according to claim 1, wherein one of the distributed file systems of the respective storage node is a master and processes the operation requests for the file in the distributed file systems of the other storage nodes.

6. The file storage system according to claim 1, wherein the management processing for the file is file stubbing or migration between the first storage system and the second storage system.

7. The file storage system according to claim 6,
wherein files are stored in the second storage system by a second file system,
the distributed file system has a tiered structure, and the second file system does not have a tiered structure, and
the file virtualization unit performs the management processing for the file between the distributed file system and the second file system.

8. The file storage system according to claim 1,
wherein the state information management unit creates a log of the operation request in addition to updating the state management information, and
the file virtualization unit performs management processing for the file on the basis of the log of the operation request.

9. The file storage system according to claim 8, wherein the state information management unit registers information to be used for access to the file in the log without change in a period from generation to deletion of the file.
